(19) United States
(12) Patent Application Publication
(10) Pub. No.: US 2025/0211263 A1
(43) Pub. Date: Jun. 26, 2025

(54) TRANSMITTER / RECEIVER FOR TRANSMITTING AND RECEIVING AN ELECTROMAGNETIC SIGNAL AND METHOD FOR TESTING A TRANSMITTER / RECEIVER

(71) Applicant: dSPACE GmbH, Paderborn (DE)

(72) Inventor: Niklas LANGE, Paderborn (DE)

(73) Assignee: dSPACE GmbH, Paderborn (DE)

(21) Appl. No.: 18/989,282

(22) Filed: Dec. 20, 2024

(30) Foreign Application Priority Data
Dec. 22, 2023 (DE) 10 2023 136 511.8

(51) Int. Cl. H04B 1/00; H04B 1/04; H04B 1/16; H04B 17/00; H04B 17/15; H04B 17/20

(52) U.S. Cl. CPC H04B 1/0089; H04B 1/0483; H04B 1/1607; H04B 17/0085; H04B 17/15; H04B 17/20

(57) ABSTRACT

A transmitter/receiver for transmitting and receiving an electromagnetic signal. The electromagnetic signal is provided for exchange with a sensor for object detection. The transmitter/receiver has an analog part which is set up to: convert a first signal at least at one intermediate frequency level into a second signal at a transmission frequency level and output the second signal as an electromagnetic signal via an output; receive a third signal as an electromagnetic signal via an input; and/or convert the third signal at the transmission frequency level into a fourth signal at the at least one intermediate frequency level. The third signal can be derived from the second signal. The transmitter/receiver is set up to generate a test signal and feed it into the analog part as the first signal and to test the analog part by comparing the test signal and the fourth signal.

This nonprovisional application claims priority under 35 U.S.C. § 119(a) to German Patent Application No. 10 2023 136 511.8, which was filed in Germany on Dec. 22, 2023, and which is herein incorporated by reference.

### BACKGROUND OF THE INVENTION

### Field of the Invention

The application relates to a transmitter/receiver for transmitting and receiving an electromagnetic signal and a method for testing a transmitter/receiver for transmitting and receiving an electromagnetic signal. The application also relates to a testing device for a transmitter/receiver and to the use of the testing device. Such a transmitter/receiver is used, for example, as an object simulator for a vehicle radar sensor.

### Description of the Background Art

DE102021131263A1, which corresponds to US 2023/0168342, which describes a method and a radar target simulator for generating a simulated radar echo signal. For the testing of radar sensors, e.g., for automated vehicles, radar target simulators are used, which detect a radar signal of a radar sensor to be tested, calculate a radar echo of the signal on the basis of a real-time model and generate a delayed response signal corresponding to the calculated echo and beam it on the radar sensor to be tested. In this way, the radar sensor is simulated to detect a physical target.

### SUMMARY OF THE INVENTION

It is therefore an object of the invention to provide a transmitter/receiver for transmitting and receiving an electromagnetic signal, the electromagnetic signal being provided for exchange with a sensor for object detection. For example, the transmitter/receiver can be part of a simulation environment for the sensor for object detection.

The transmitter/receiver can have an analog part that is set up to: convert a first signal at least at one intermediate frequency level into a second signal at a transmission frequency level and output the second signal as an electromagnetic signal via an output; and receive a third signal as an electromagnetic signal via an input, and to convert the third signal in the transmission frequency level into a fourth signal in the at least one intermediate frequency level, wherein the third signal is derived from the second signal.

The transmitter/receiver is set up to generate a test signal and feed it into the analog part as the first signal, as well as to test the analog part by comparing the test signal and the fourth signal.

A method for testing such a transmitter/receiver for transmitting and receiving an electromagnetic signal comprises: generating a test signal and feeding the test signal into the analog part as the first signal; deriving the third signal from a second signal; and testing the analog part by comparing the test signal and the fourth signal.

The electromagnetic signal can be provided to be exchanged with a sensor for object detection, wherein the transmitter/receiver has an analog part that is set up to convert the first signal at least at one intermediate frequency level into the second signal at a transmission frequency level and to output the second signal as an electromagnetic signal via an output. The analog part is further set up to receive a third signal as an electromagnetic signal via an input and to convert the third signal in the transmission frequency level into a fourth signal at the at least one intermediate frequency level.

With this transmitter/receiver or the corresponding method, it is then possible to carry out a self-test of the transmitter/receiver and in particular of the analog part. The self-test is thus possible directly at the place of use of the transmitter/receiver, e.g., at a user of the simulation environment that the transmitter/receiver has. The transmitter/receiver no longer needs to be returned to the manufacturer for a new calibration.

In addition, the transmitter/receiver is robust, as no additional or only passive components such as filters are required for the self-test or the test of the transmitter/receiver described above, which are hardly subject to aging. Furthermore, such a transmitter/receiver is characterized fact that it has a test mode in which the self-test is carried out and a working mode in which the transmitter/receiver is used as an object simulator, also called a target simulator, for the sensor for object detection. These two modes are disjoint in time and can be run separately.

Such a transmitter/receiver can therefore be used as an object simulator, which has the option of self-testing. Accordingly, the method for testing the transmitter/receiver allows for a simple and/or robust way of self-testing such a transmitter/receiver.

The transmitter/receiver for transmitting and receiving an electromagnetic signal is, for example, a radar device or radar sensor that sends and also receives corresponding radar signals as an electromagnetic signal. However, it can also be a lidar device that sends and receives corresponding lidar signals as an electromagnetic signal. With such transmitter/receivers, it is possible to test the function of a radar or lidar sensor by the transmitter/receiver sending radar or lidar signals back to the radar sensor, which the radar sensor or lidar sensor interprets as reflected radar signals or lidar signals on the radar or lidar signals emitted by it. This allows for such transmitters/receivers to simulate different environments with different reflection behavior according to specifications. For the radar or lidar device, such synthetically produced reflection signals can be used to simulate the environments with simulated objects.

The simulation environment in which the transmitter/receiver may be located can be designed in such a way, e.g., by means of absorbers, that it does not reflect radar or lidar signals. This makes it possible to create a controlled reflection produced by one or more transmitters/receivers in order to create virtually any environment for the radar sensor or lidar sensor.

The transmitter/receiver in working mode thus receives the electromagnetic signal from the sensor for object detection, e.g., the radar or lidar sensor, wherein the transmitter/receiver passes on a reception signal derived from the electromagnetic signal to a computer or to a programmable logic device, which, as a function of this receiving signal and other stored data, instructs the transmitter/receiver to emit a corresponding simulated reflection signal. Specifically, the transmitter/receiver receives the third signal in working mode, generates an echo signal, e.g., to simulate an object, and outputs the second signal as a function of the echo signal. The generation of the echo signal can include a calculation and/or an analog generation, e.g., by means of delay elements, dampers, or the like.

The electromagnetic signal can be, for example, a high-frequency signal emitted by the transmitter/receiver via an antenna or as an optical signal emitted by a laser.

The sensor for object detection is then, for example, the radar or lidar sensor, for which the transmitter/receiver simulates the reflected signal. Other sensors are conceivable that can detect one or more objects via an electromagnetic signal.

The transmitter/receiver can have an analog part which, at least at an intermediate frequency level, converts a first signal into a second signal at a transmission frequency level. This conversion can be carried out, for example, in steps over several intermediate frequencies at a respective intermediate frequency level, or at one time from an intermediate frequency at an intermediate frequency level to the transmission frequency at the transmission frequency level. The intermediate frequency level or even several of them are below the frequency of the transmission frequency level in terms of frequency. At the intermediate frequency level, easier signal processing is possible in the analog part than in the higher frequency of the transmission frequency level. The transmission frequency for the electromagnetic signal is, for example, 20 GHz or 77 GHZ or other frequencies in the microwave range that are suitable for radar signals. In the case of a radar signal, for example, the output is one or more horn antennas or a so-called antenna array or other antenna types or antenna configurations or even without antennas at all. When using lidar signals, there is a conversion into an optical signal, which is output as an electromagnetic signal. These optical signals are, for example, in the near-infrared range or in the visible range of light. Other light ranges are possible.

In the analog part, the conversion from the at least one intermediate frequency level to the transmission frequency level is achieved, for example, by so-called mixing. In the process, unwanted mixed products can be filtered out. Amplifiers are also provided in the analog part. In particular, active components such as mixers or amplifiers are subject to an aging process that requires calibration and, if necessary, adjustment of parameters. The precision that can be achieved by calibrating and, if necessary, adjusting parameters is advantageous in order to be able to consistently emit an identical electromagnetic signal with which the sensor for object detection can be tested.

Accordingly, the transmitter/receiver can have one or more receiving antennas in the receiving section of the analog part for receiving the electromagnetic signal at the input. A downmixing of the received electromagnetic signal into the at least one intermediate frequency level and corresponding amplification of the received and downmixed signal are provided.

The transmitter/receiver can be set up to generate a test signal and feed it into the analog part and thereby into the transmitting part as the first signal. This test signal can also be generated in the analog part itself or in a digital part. Alternatively, it can also be fed in from outside.

This test signal can be used to check a first signal path in the transmitting part until the electromagnetic signal is sent. The test signal is also used to test a second signal path in the receiving section. The test signal is used in particular to test the first and second signal paths together. Such a self-test corresponds to a calibration that would otherwise have to be carried out regularly with the transmitter/receiver by the manufacturer of such a simulation environment.

The first signal can be the test signal, which runs through the first signal path, the transmission signal path, at the at least one intermediate frequency level. The second signal is obtained from the first signal by a conversion to the transmission frequency level. The second signal is output as an electromagnetic signal through the output, either into the space located at the output, so that the second signal propagates as an electromagnetic wave, or into a connector attached to the output that connects the output to the input. The third signal is received as an electromagnetic signal through the space or via the connector at the input. The fourth signal is derived from the third signal by a conversion into the at least one intermediate frequency level and is used for comparison with the test signal. These signals can be subjected to amplification and filtering as well as other signal shaping in the analog part.

A testing device can be set up for testing the transmitter/receiver. For example, the testing device may have a reflection device for the second signal to derive the third signal. The second signal output via the output can then be reflected back to the input as a third signal via the reflection device.

Furthermore, the testing device can be used to calibrate the analog part, wherein stored calibration data of the analog part is changed as a function of the comparison of the test signal with the fourth signal. Changing the calibration data may involve overwriting the existing calibration data with the new calibration data obtained from the comparison. Other possibilities are also conceivable, in which a difference to the previous value is stored.

The connector can be provided for deriving the third signal from the second signal between the output and the input. Via such a defined connection via the connector, it is then specified that the second signal is not influenced by the environment in an unforeseen way, instead, through the connector, the change acting on the second signal to derive the third signal is known from the outset. This means that no other factors need to be taken into account during the self-test of the transmitter/receiver. The connector can be designed as a waveguide or, in the optical case, as an optical fiber.

The connector can be designed for attenuation and/or phase shift and/or frequency shift of the second signal to derive the third signal. The connector can therefore have corresponding attenuation or also cause a phase shift or a frequency shift or a combination of these changes.

The connector can have at least one λ/4 and/or at least one λ/2 and/or at least one 3/4 λ-delay element. With such defined delays by the corresponding wavelength of the electromagnetic signal, which is denoted by λ, appropriate tests of the analog part, such as error identification, can then be carried out.

In addition, the connector may have a high-pass filter. This makes it possible to ensure that only frequencies above a specified cut-off frequency of the high-pass filter can pass through the connector. All lower frequencies are filtered out by the high-pass filter. This can be used to eliminate unwanted mixed products, for example.

The transmitter/receiver can be designed to derive attenuation and/or amplification of the analog part from the comparison of the test signal with the fourth signal. As described, both the transmission signal path in the analog part for sending the electromagnetic signal and the reception signal path in the analog part for receiving the electromagnetic signal can each have amplifiers that amplify the corresponding signal. Furthermore, the entire signal path in the analog part has attenuation in both the transmitting part and the receiving section. In addition, there is corresponding attenuation of the signal by sending the electromagnetic signal over the atmosphere or via the connector. By taking an overall view, the transmitter/receiver is then able to determine whether there is overall attenuation or amplification of the signal that travels the signal paths and the path as an electromagnetic signal.

Furthermore, examples may provide that the transmitter/receiver can be set up to derive a phase difference between the test signal and the fourth signal from the comparison of the test signal and the fourth signal. This can be evaluated digitally or analog, so that it can be identified which phase difference the signal path ultimately imprints on the test signal by the analog part and, if necessary, the connector or atmosphere. Therefore, the transmitter/receiver can determine a time-of-flight of the test signal through the analog part from this phase difference. The time-of-flight through the connector is known in advance, even if a reflection plane is used, this is known in advance and thus it is possible to determine the time-of-flight that is only covered in the analog part.

The transmitter/receiver can have a digital part that is set up to generate the test signal and feed it into the analog part as the first signal, as well as to evaluate the fourth signal and, for example, to carry out the comparison between the test signal and the fourth signal. To perform the comparison, the digital part may have a comparator that compares the test signal with the fourth signal. For example, the comparator may have a processor and/or other signal-processing circuits. The test signal to be fed into the analog part as the first signal can be stored in a memory from which the digital part takes the test signal in order to feed it into the analog part. However, there may also be circuits or functions by means of which the test signal is generated in each case.

In addition, it is possible that the test signal can be formed as a sinusoidal signal or a superposition of several sine waves. Sine signals are to be regarded as particularly suitable for such a self-test or analog signal test. Alternatively, other periodic or aperiodic signals can also be used.

As described, the electromagnetic signals can be provided for exchange with the sensor for object detection. This means that the electromagnetic signals have a transmission frequency which enables the sensor for object detection to receive them correctly. Such a sensor for object detection can be, for example, a radar sensor or a lidar sensor, and the transmission frequency is accordingly in the radar range or in the lidar range.

The transmitter/receiver can be set up to simulate objects to be detected by means of electromagnetic signals for sensors for object detection, e.g., radar sensors or lidar sensors. As indicated above, the transmitter/receiver, or a plurality of these transmitters/receivers, can simulate any environment for the sensor for object detection, such as the radar sensor or the lidar sensor. This simulation involves emitting electromagnetic signals according to this simulated environment, as if these electromagnetic signals had been reflected at these objects in the simulated environment.

It is also provided that the transmitter/receiver can be set up to determine a minimum distance of the object to be simulated using the time-of-flight of the test signal and the analog part.

Stored calibration data of the analog part can be changed as a function of the comparison of the test signal with the fourth signal. If there are changes in the analog part over time, for example due to a deterioration of one or more amplifiers, this can be taken into account in the calibration data, so that such long-term changes do not have a negative impact on the functioning of the transmitter/receiver.

The same applies to the method for testing the transmitter/receiver.

In particular, the method can be run several times. For example, different delay elements can be used for the different runs. The analog part of the transmitter/receiver can thus be tested under different circumstances in which the derivation of the third signal differs from the second signal. From the results of the various comparisons during the multiple runs of the method, the condition of the analog part of the transmitter/receiver can then be deduced and, if necessary, parameters can be changed, and errors can be detected.

Further scope of applicability of the present invention will become apparent from the detailed description given hereinafter. However, it should be understood that the detailed description and specific examples, while indicating preferred embodiments of the invention, are given by way of illustration only, since various changes, combinations, and modifications within the spirit and scope of the invention will become apparent to those skilled in the art from this detailed description.

### BRIEF DESCRIPTION OF THE DRAWINGS

The present invention will become more fully understood from the detailed description given hereinbelow and the accompanying drawings which are given by way of illustration only, and thus, are not limitive of the present invention, and wherein:

FIG. 1 shows a block diagram of the transmitter/receiver;

FIG. 2 shows another block diagram of the transmitter/receiver;

FIG. 3 shows a flowchart of the method according to the application;

FIG. 4 shows a schematic representation of the testing device; and

FIG. 5 shows a schematic representation of the simulation environment.

### DETAILED DESCRIPTION

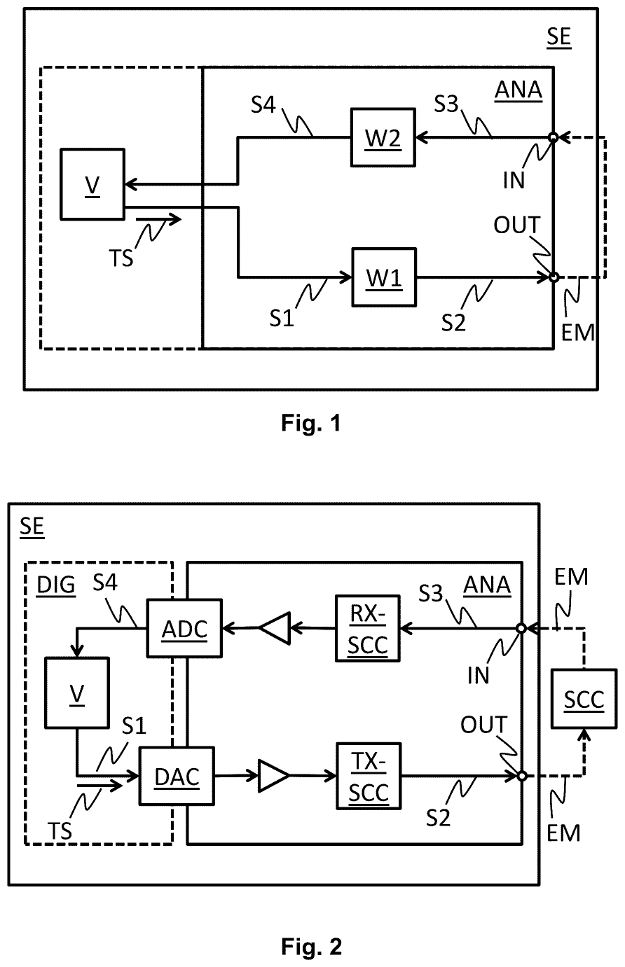

FIG. 1 shows a transmitter/receiver SE. The transmitter/receiver SE has a comparator V which generates a test signal TS. This test signal TS is fed into an analog part ANA and as the first signal S1 into a first converter W1. The first converter W1 converts this into the second signal S2, which is output via the output OUT as an electromagnetic signal EM. This means that the electromagnetic signal EM is then present as a propagating electromagnetic wave. Optionally, a connector SCC can be provided between output OUT and input IN, which conducts the electromagnetic signal EM from the output OUT to the input IN.

Propagation in space can also be provided between output OUT and input IN. A change in direction of the electromagnetic signal EM can then be achieved, for example, by providing a reflection device REF.

For example, the first converter W1 can be a mixer that upmixes the first signal S1 from at least one intermediate frequency level to a transmission frequency level. Therefore, the second signal S2 can then be a radio frequency signal in the transmission frequency, for which, e.g., a waveguide is connected to the output of the first converter W1.

The comparator V can optionally be part of the analog part ANA. Optionally, the comparator V can also be provided outside the analog part ANA.

The electromagnetic signal EM is received via the input IN. If, for example, the electromagnetic signal EM is a radar signal, corresponding antennas such as horn antennas, but also other antennas, can be provided at both the output OUT and the input IN.

For example, if the electromagnetic signal EM is an optical signal such as a lidar signal, then a laser or a laser array can be provided at the output OUT and a light receiver, or a field of such light receivers can be provided at the input IN. In this case, there is an electro-optical converter such as a laser at the output OUT and an optical-electrical converter, such as a photodiode, at the input IN.

The third signal S3 is transmitted from the input IN to the second converter W2, e.g., via waveguides, where it is converted into the fourth signal S4. This conversion is then achieved, for example, by mixing down from the transmission frequency of the transmission frequency level to the at least one intermediate frequency of the at least one intermediate frequency level.

The fourth signal S4 is then compared with the test signal TS in the comparator V and from this, for example, attenuation and/or a phase shift and/or a frequency shift are determined. The determined one attenuation and/or phase shift and/or frequency shift then refers to the analog part of the transmitter/receiver SE and provides information about its status. In particular, the values can be compared with target values, for example, and parameters derived from them can then be determined, for example.

For the sake of clarity, other possible components of the transmitter/receiver SE such as filters or amplifiers are not shown in FIG. 1.

FIG. 2 shows another block diagram of the transmitter/receiver SE. In the present case, the comparator V is arranged in a digital part DIG. Accordingly, the first signal S1 or test signal is converted from a digital signal to an analog signal by a digital to analog converter DAC.

This first signal S1 can be filtered and amplified, and then converted in the TX-SCC transmitting transducer from the intermediate frequency to the second signal S2 in the transmission frequency, to then be sent out via the output OUT as an electromagnetic signal EM.

In the present case, the connector SCC is connected by way of example to the output OUT and the input IN in order to form a connection for the electromagnetic signal EM between the output OUT and the input IN. The connector SCC can change the attenuation, phase and/or frequency. Active parts may even be provided in the connector.

Then the electromagnetic signal EM is again fed into the receiving section of the analog part ANA via the input IN and as the third signal S3 it then arrives in the receiving transducer RX-SCC. The receiving transducer RX-SCC mixes the third signal S3 from the transmission frequency level into the intermediate frequency level, so that the fourth signal S4 is present at the intermediate frequency level at the output of the receiving transducer RX-SCC. The analog fourth signal S4 is amplified and filtered if necessary, and then fed into an analog to digital converter ADC, which generates the digital fourth signal S4 therefrom, which is fed into the comparator V for comparison with the test signal TS. For example, the comparator V can run on a processor, but other circuits are also possible for this comparison.

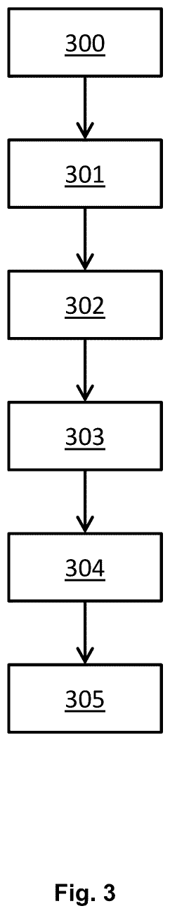

FIG. 3 shows a flowchart of the method for testing a transmitter/receiver SE.

In 300, the test signal TS is generated and is fed into the analog part ANA as the first signal S1. The test signal TS can be generated by a signal generator, for example, or read out from a memory. The generation of the test signal TS and the forwarding to the analog part ANA can be carried out, for example, by the comparator V.

In 301, the first signal S1 is converted into the second signal S2. This conversion includes an upmixing from the intermediate frequency to the transmission frequency.

In 302, the second signal S2 is output via the output OUT as an electromagnetic signal EM.

In 303, the electromagnetic signal EM is received as the third signal S3 derived from the second signal S2. This derivation can be done, for example, by the connector SCC, which connects the output OUT with the input IN and thus conducts the electromagnetic signal EM.

In 304, the third signal S3 is converted into the fourth signal S4. This conversion involves a downmixing from the transmission frequency to the intermediate frequency.

In 305, the test signal TS and the fourth signal S4 are compared with each other. As a function of the comparison, the transmitter/receiver SE can then be calibrated, for example.

For example, an attenuation or a reinforcement of the analog part ANA can be derived from the comparison. In addition, a phase difference can be derived from the comparison between the test signal TS and the fourth signal S4. In particular, the method can be run several times. For example, during the different runs of the method, connectors with different delay elements, e.g., a λ/4 delay element and/or a λ/2 delay element and/or a 3/4 λ-delay element, can be used. By comparing the results with the various delays, conclusions can then be drawn about how good the calibration state of the transmitter/receiver SE is and, if necessary, stored calibration data, especially of the analog part ANA, can be changed as a function of the comparison. In addition, errors can be detected during measurement.

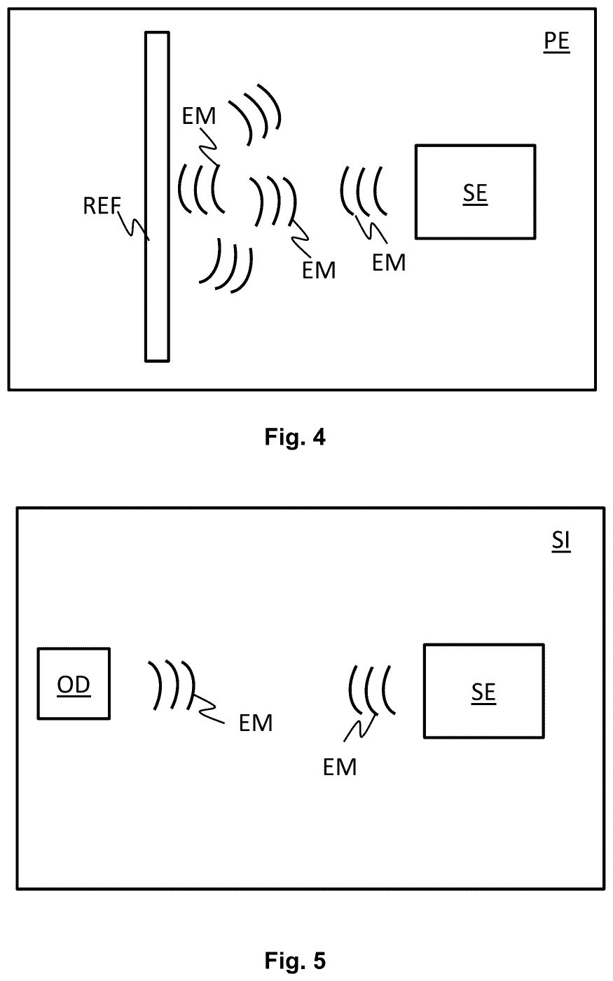

FIG. 4 shows a testing device PE in which the transmitter/receiver SE is located. As shown above, the transmitter/receiver SE emits the electromagnetic signal EM via the output OUT, which in this case is reflected at a reflection device REF, for example a plate, in order to then receive the reflection signal again from the transmitter/receiver SE via the input IN. This is an alternative to the connector SCC.

FIG. 5 shows a simulation environment SI with the transmitter/receiver SE emitting an electromagnetic signal EM and a sensor for object detection OD, such as a radar sensor or a lidar sensor. The sensor for object detection OD also sends such an electromagnetic signal EM. If the sensor for object detection OD determines its environment, for example via the time-of-flight principle, the time-of-flight is evaluated. Radar sensors usually use the Doppler effect, i.e., a frequency shift. The time-of-flight evaluation is often used for the lidar sensor, but it is also possible to apply a Doppler shift here. However, other measurement methods are also possible.

The invention being thus described, it will be obvious that the same may be varied in many ways. Such variations are not to be regarded as a departure from the spirit and scope of the invention, and all such modifications as would be obvious to one skilled in the art are to be included within the scope of the following claims.

What is claimed is:

1. A transmitter/receiver for transmitting and receiving an electromagnetic signal, the electromagnetic signal being provided for an exchange with a sensor for object detection, the transmitter/receiver comprising:
an Input;
an output; and
an analog part which is set up to convert a first signal at least at one intermediate frequency level into a second signal at a transmission frequency level and output the second signal as an electromagnetic signal via the output, to receive a third signal as an electromagnetic signal via the input, and to convert the third signal at the transmission frequency level into a fourth signal at the at least one intermediate frequency level,
wherein the third signal is derived from the second signal, and
wherein the transmitter/receiver is set up to generate a test signal and feed it into the analog part as the first signal and to test the analog part by comparing the test signal and the fourth signal.

2. The transmitter/receiver according to claim 1, further comprising a connector for deriving the third signal from the second signal between the output and the input.

3. The transmitter/receiver according to claim 2, wherein the connector is designed for attenuation and/or a phase shift and/or a frequency shift of the second signal for the derivation of the third signal.

4. The transmitter/receiver according to claim 3, wherein the connector has at least one λ/4 and/or at least one λ/2 and/or at least one 3/4 λ-delay element.

5. The transmitter/receiver according to claim 2, wherein the connector has a high-pass filter.

6. The transmitter/receiver according to claim 1, wherein the transmitter/receiver is configured to derive from the comparison an attenuation or amplification of the analog part.

7. The transmitter/receiver according to claim 1, wherein the transmitter/receiver is set up to derive a phase difference from the comparison between the test signal and the fourth signal.

8. The transmitter/receiver according to claim 7, wherein the transmitter/receiver is set up to determine from the phase difference a time-of-flight of the test signal through the analog part.

9. The transmitter/receiver according to claim 1, wherein the transmitter/receiver comprises a digital part which is set up to generate the test signal and to feed it into the analog part as the first signal as well as to perform the comparison.

10. The transmitter/receiver according to claim 1, wherein the test signal is formed as a sine signal or a superposition of several sine signals.

11. The transmitter/receiver according to claim 1, wherein the electromagnetic signals are provided for exchange with a radar sensor or with a lidar sensor.

12. The transmitter/receiver according to claim 11, wherein the transmitter/receiver is configured to simulate objects to be detected by means of the electromagnetic signals for the radar sensor or the lidar sensor.

13. The transmitter/receiver according to claim 12, wherein the transmitter/receiver is configured to determine a minimum distance of the object to be simulated using the time-of-flight of the test signal through the analog part.

14. A testing device comprising the transmitter/receiver according to claim 1.

15. The testing device according to claim 14, further comprising a reflection device for the second signal for the derivation of the third signal.

16. The testing device according to claim 14, wherein the testing device calibrates the analog part, and wherein stored calibration data of the analog part are changed as a function of the comparison.

17. A method to test a transmitter/receiver for transmitting and receiving an electromagnetic signal, the electromagnetic signal being provided for exchange with a sensor for object detection, the method comprising:
providing the transmitter/receiver with an analog part;
converting a first signal at least at one intermediate frequency level into a second signal at a transmission frequency level and output the second signal as an electromagnetic signal via an output;
receiving a third signal as an electromagnetic signal via an input;
converting the third signal at the transmission frequency level into a fourth signal at the at least one intermediate frequency level;
generating a test signal and feeding the test signal into the analog part as the first signal;
deriving the third signal from the second signal; and
testing the analog part by comparing the test signal and the fourth signal.

18. The method according to claim 17, wherein attenuation or amplification of the analog part is derived from the comparison.

19. The method according to claim 17, wherein a phase difference is derived from the comparison between the test signal and the fourth signal.

20. The method according to claim 17, wherein stored calibration data of the analog part are changed as a function of the comparison.
